(19) United States
(12) Patent Application Publication
(10) Pub. No.: US 2002/0073231 A1
(43) Pub. Date: Jun. 13, 2002

(54) Tracerouting a list of internet hosts

(76) Inventors: John S. Quarterman, Austin, TX (US); Paul Murphy, Edinburg (GB)

Correspondence Address: DRINKER BIDDLE & REATH, ONE LOGAN SQUARE, 18TH AND CHERRY STREETS, PHILADELPHIA, PA, 19103-6996, US

(21) Appl. No.: 09/834,315

(22) Filed: Apr. 13, 2001

Related U.S. Application Data
(60) Provisional application No. 60/198,610, filed on Apr. 19, 2000.

(51) Int. Cl. G06F 15/173; G06F 15/16

(52) U.S. Cl. 709/238; 709/224; 709/230

(57) ABSTRACT

A method and system for monitoring the internet is defined. An embodiment of the invention invovles the following steps: providing a traceroute specification and a set of global defaults; parsing the specification into its constituent parts; setting up a transaction request message; creating a TCP/IP socket and setting up input/output access to it; and for each potential “hop” up to the maximum allowed, sending a “ping” to the destination with the max allowed hops for that “ping” and setting the message to one more than the ping to the previous potential hop (where the numbering started at one); noting the timestamp for that ping transmission; waiting for a reply from the ping; noting the timestamp for that reply when it arrives and then calculate the time taken from transmit to reply; and closing the socket and server connection.

### CROSS-REFERENCE TO RELATED APPLICATIONS

This application claims the priority of U.S. application Ser. No. 60/198,610 filed Apr. 19, 2000.

### FIELD OF THE INVENTION

The invention relates to monitoring of computer networks. More specifically, the invention relates to monitoring of the internet.

### BACKGROUND OF THE INVENTION

A need to speed up collection of massive data related to the internet has existed for many years. The largest known traceroute collection system collects limited amounts of data. Known systems simply use several fast computers to collect the data. That approach is problematic in that it can not be scaled. Because looking up the name of a “hop” (from the Internet address received in the reply to the ping to that hop) takes a long time, processing can't proceed as fast as possible. Further, performing known traceroutes in sequence takes a long time, a significant amount of which is wasted waiting for Responses from the remote servers. In addition, performance timings can be negatively affected by the act of reading traceroute specs from, or writing measurements to, disk storage. Moreover, the network interface and possibly the measurement processor can become overloaded if there are too many traceroutes performed in parallel. Such an overlaod can make the performance measured appear worse that it actually is for some sites. Further still, the computer operating system may limit the number of communication “sockets” that may be open simultaneously (to a number much less than the desire number of “threads”). Complicating the process further, batches of traceroutes can not complete in a timely fashion when remote servers fail to reply. It takes a very long time to detect a remote server failure and hence that traceroute takes a long time to complete (even in failure). Since all traceroutes in a batch (also known as a chunk) need to complete before the batch itself can complete, processing of the entire list is delayed. Further still, because the “pings” to a hop are not always reliable, some remote servers seem to be out of service when they are not. Also, there is variation in the time taken for the ping to complete. Yet another problem is that messages can be received from the remote servers (the “hops”) other than the expected reply to the ping, causing the program to get confused.

Known traceroute's UDP requests, because they run through a sequence of UDP ports per destination, often set off alarms in firewall software that misperceives them as attacks. This results in complaints about the traceroutes. Responding to those complaints takes time and effort that can better be used elsewhere. Also, UDP packets do not carry adequate identification information through to ICMP error responses to match up the latter to the former.

Merely running multiple traceroutes simultaneously in a chunk does not produce adequate speed of data collection. Unlike mping, mtraceroute involves multiple hops with different times to live per destination, not just several identical probes per destination. A traceroute to a destination is only complete when ICMP error responses have been returned for all hops up until the one that returns an ICMP ECHO response, or until the maximum number of hops is reached, including 3 responses for each such hop. Running through each hop for a destination in sequence is slow, particularly in cases where mtraceroute is occasionally used on few destinations, even on a single destination. Even for a large chunk size, a single destination could hold up completion of the entire chunk. by four and a half minutes. If simhops equals maxhops many unneeded pings will be sent for hops beyond the successful hop. This wastes local and network resources and slows down data collection. If simhops is less than maxhops, pinging only simhops hops per destination could cause some legitimate hops not to be pinged.

### SUMMARY OF THE INVENTION

The invention is directed to a data gathering utility that performs “traceroute” operations to a list of Internet hosts (i.e. computers) and records the various performance and success/failure measurements that are standard with the traditional traceroute operation.

A “traceroute” operation involves querying the Internet as to the “path” that messages take when going from one computer to another. In other words, traceroute asks for the list of computers that a message is routed through on its way to the final destination for that message.

The mtraceroute program accepts a list of Internet addresses and operational options and stores a data log of the performance and reachability measurements taken while executing each of those traceroutes. For each destination site specified in the master list, the sub-list of computers through which a message is routed is gathered (where each intermediate computer is known as a “hop”). The data gathered for each “hop” includes: the order of the hop (i.e. was it the 3rd or 4th waypoint, etc); the Internet Address (i.e. IP address); the Name of the computer (i.e. Domain Name) whether that “hop” responded (i.e. was reachable); and total time taken receiving each response from a hop.

This program is preferably implemented in C and therefore may run on multiple computer operating systems. This property of the program has been demonstrated by its first implementations running simultaneously under Solaris on SPARCs and under Linux on Intel boxes.

An embodiment of the invention performs name lookups (i.e. DNS lookup) in advance thus causing the name information to be “fresh” in the DNS server (i.e. cached).

An embodiment of the invention establishes a time limit for each DNS operation to complete. If it is not complete in time, it is abandoned and that hop is considered “unnamed” rather than waiting. This allows processing to continue and a cap on server response time to be established.

An embodiment of the invention uses “multi-threading” to perform, in parallel, more than one traceroute measurement at a time.

An embodiment of the invention reads in a batch (also known as a chunk) of specifications up front, performs and measures those traceroutes in parallel (holding on to the data in fast memory), and when the batch is completed, writes out all of the measurements for the batch to the data log on (slow) disk. Batches are repeat processed until the complete list is processed. The size of the batch is limited by the amount of fast memory available. However, the size of the batch is more usually set to permit enough simultaneous flying pings without overloading the local CPU.

An embodiment of the invention controls or limits the number of traceroutes performed in parallel independently of the batch size. The number of threads is limited by the capacity of the network interface, the amount of processing power available.

An embodiment of the invention multiplexes all network transmissions through a single “socket” and de-multiplex the replies received by handing each reply to the appropriate “thread” awaiting that reply.

An embodiment of the invention establishes an arbitrary time limit for each “ping” operation to complete. If it is not complete in time, it is abandoned and considered that the “hop” is a failure on the remote server's part rather than waiting for the computer system to detect that a failure has occurred. This allows processing to continue and a cap on server response time to be established in the statistical categories.

An embodiment of the invention performs more than one ping per hop and averages the results to get a more representative picture of performance and reachability.

An embodiment of the invention filters out all unwanted messages at the point of message receipt and only passes the expected messages on to the rest of the program.

An embodiment of the invention does not use UDP at all. It sends ICMP ECHO requests instead. These do not set off the same kind of alarms as UDP traceroute does. Thus fewer complaints are received. The ICMP ECHO requests are sent in such a way as to transfer sufficient identification to ICMP error and ECHO responses so that mtraceroute can match them up to their corresponding ICMP ECHO requests.

The invention is not only directed to the chunking, but rather that each chunk of destinations that is read in provides a larger set of potential pings (chunks*simdest*simhops) than are permitted to be flying (simpings) at a given time. Thus when a ping is finished (response received or max time exceeded), another ping can start immediately, thus keeping the number of pings flying high. While the total number of destinations in the chunk may be large (chunks*simdest), the number of simultaneous running destinations with flying pings is smaller (simdest), and mtraceroute completes the entire traceroute for a running destination before declaring that destination complete and thus decreasing the number of running destinations and permitting another destination to start running.

An embodiment of the invention sends a ping for each destination for each of the first simhops hops simultaneously, where 1 simhops maxhops. The maximum delay on account of a single destination (if simhops is at least as large as the highest number of hops needed for any destination) is thus typically 9 seconds, for a savings of a factor of 30.

In an embodiment of the invention, simhops is a runtime-settable option, which is preferably by default half the total number of permitted hops. That default permits most traceroutes to be completed without requiring a second pass, while minimizing the number of superfluous pings to hops after the final hops for that traceroute. Empirical evidence demonstrates that a typical traceroute takes about 7 hops and few traceroutes take more than 14 hops, thus simhops equal to 15 is an adequate default.

If a successful hop is not encountered for a destination in simhops hops, an embodiment of the invention pings the next simhops hops for that destination, and so on until maxhops or a successful hop is reached.

### DETAILED DESCRIPTION OF A PREFERRED EMBODIMENT

As long as there remain traceroute specifications left in a provided input list, the next specification is read, the corresponding traceroute is performed while timing its performance (explained in greater detail below), and, the measurements are written to the data log.

A preferred method involves the following steps: providing a traceroute specification and a set of global defaults; parsing the specification into its constituent parts; setting up a transaction request message; creating a TCP/IP socket and setting up input/output access to it; and for each potential “hop” up to the maximum allowed, sending a “ping” to the destination with the max allowed hops for that “ping” and setting the message to one more than the ping to the previous potential hop (where the numbering started at one); noting the timestamp for that ping transmission; waiting for a reply from the ping; noting the timestamp for that reply when it arrives and then calculate the time taken from xmit to reply; closing the socket and server connection

There are four nested levels of queues. The input file is provided. Chunk: simdest destinations are drawn from the input file. Running destinations: simdest destinations are drawn from the remaining uncompleted destinations in the chunk (which could be considered a fifth level). Flying pings: simping pings are drawn from the running destinations, simhops per running destination at a time.

### EXAMPLES

Mtraceroute help is defined. Usage is: mtraceroute [opts] [destination] mtraceroute traceroutes to the destination domain name or to a list of destinations specified with -f filename. It uses multiplexed ICMP echo for speed. With a single argument destination it emulates traceroute output. With -f filename it prints multiple traces on standard output. Specific options can include:

| | | |
|---|---|---|
| -h, | --help | this help message |
| -s n, | --size=bytes | packet size in bytes (64) |
| -p x, | --pattern=x | to fill packet data bytes (97784) |
| -n n, | --series=pings | pings per hop per destination (3) |
| -t n, | --simhops=hops | simultaneous hops (TTLs) per destination |
| | | (15) |
| -m n, | --maxhops=hops | max hops (TTLs) per destination (30) |
| -d n, | --simdest=dests | simultaneous destinations per chunk |
| | | (3) |
| -e n, | --simping=pings | simultaneous pings (15) |
| -c n, | --chunks=n | chunks between file I/O (10) |
| -w, | --waitsecs=n | for response; default 5 (3 with one |
| | | argument |
| | | dest) |
| -i, | --initialttl=hop | skip all hops before this one |
| -l, | --showttl | print returned TTLs |
| -v, | --verbose | verbose: isn't supposed to affect |
| | | timing |
| -D, | --debug=n | debug: will damage timing (0) |
| -I, | --printinput | print input packet |
| -R, | --dontrevdns | Don't do reverse DNS lookups |
| -N, | --dontforkdns | Don't fork DNS subprocess |
| -P, | --precomputedns | Precompute DNS onto stdout and don't |
| | | ping |
| -f, | --infile=infile | input filename |
| , | destination | optional destination |

An example output for a single destination follows. traceroute to www.lockeliddell.com (205.240.201.4), 30 hops max, 64 byte packets

1. ***

2. psinet-gw (38.159.59.1) 9.003 ms 3.004 ms 4.001 ms

3. fr.austin2.tx.psi.net (38.2.200.1) 13.008 ms 4.006 ms 4.006 ms

4. 38.1.42.7 (38.1.42.7) 27.009 ms 16.008 ms 19.009 ms

5. 38.1.22.193 (38.1.22.193) 28.005 ms 18.003 ms 19.000 ms

6. 38.1.10.45 (38.1.10.45) 66.004 ms 59.002 ms 59.001 ms

7. 204.6.118.198 (204.6.118.198) 69.001 ms 62.002 ms 62.002 ms

8. pao6.pao5.verio.net (129.250.2.129) 68.004 ms 62.001 ms 62.006 ms

9. p1-0-0.r00.d11stx01.us.bb.verio.net (129.250.2.161) 107.005 ms 101.006 ms 98.000 ms

10. ge-1-0-0.a10.d11stx01.us.ra.verio.net (129.250.31.58) 108.001 ms 101.006 ms 98.000 ms

11. fa-5-0-0.a05.d11stx01.us.ra.verio.net (199.1.141.2) 109.001 ms 101.003 ms 100.000 ms

12. 205.240.201.254 (205.240.201.254) 108.008 ms 105.007 ms 103.009 ms

13. 205.240.201.200 (205.240.201.200) 105.003 ms 102.006 ms 100.004 ms

14. host3.1prh.com (205.240.201.4) 105.000 ms 106.009 ms 103.002 ms

It should be understood that the present invention may be embodied in other specific forms without departing from the spirit or essential attributes thereof.

What is claimed is:

1. A method of monitoring a computer network comprising the steps of:
providing a traceroute specification and a set of global defaults;
parsing the specification into its constituent parts;
setting up a transaction request message;
creating a TCP/IP socket;
setting up input/output access to the TCP/IP socket;
for each potential hop up to a predetermined maximum allowed, sending a ping to a destination with the maximum allowed hops for that ping, and setting the message to one more than the ping to the previous potential hop, wherein the numbering started at one;
noting the timestamp for that ping transmission;
waiting for a reply from the ping;
observing the timestamp for the reply when it arrives calculating the time taken from transmit to reply; and
closing the socket and server connection.
